(19) United States
(12) Patent Application Publication
(10) Pub. No.: US 2003/0091779 A1
(43) Pub. Date: May 15, 2003

(54) Cutting edge for dispenser cartons

(76) Inventor: Frederick H. Brewster, Madison, WI (US)

Correspondence Address: Patent Department, H.B. Fuller Company, 1200 Willow Lake Boulevard, P.O. Box 64683, St. Paul, MN, 55164-0683, US

(21) Appl. No.: 10/008,842

(22) Filed: Nov. 13, 2001

(51) Int. Cl. B32B 3/10

(52) U.S. Cl. 428/43; 428/34.2; 428/349

(57) ABSTRACT

A process for forming a cutting edge on a carton board or box board in which a polymeric tape is adhered to a box or carton blank, cuts are made in the tape and box or carton blank and form virtual teeth that, upon folding the blank and tape to form a carton or box, produce teeth that project outward from the tape and provide a cutting edge for cutting materials dispensed from the carton or box.

### BACKGROUND

This invention relates to a process for forming a cutting edge on corrugated or fiber board boxes. In one aspect, the invention is directed to a method of forming a container blank (e.g., carton blank or box blank) and container formed therefrom, the container having a novel cutting edge formed of a polymeric tape. The cutting edge is formed of a polymeric material adhered to a container blank, and serves to cut lengths of web material from convolutely wound rolls of film, paper or foil products, disposed in the container.

Rectangular dispensing cartons are often used by consumers to dispense a roll of sheet material and are often capable of severing the sheet material at a desired length. The cartons generally have a cutter on an edge of the front panel or on the distal end of the lid to aid in cutting the sheet material. The cutter is formed with a saw-toothed edge to guide the cut across the width of the sheet material.

Examples of cutting edges include saw-toothed or serrated edges formed from metal (as shown in EP 352634 A dated 19900131, U.S. Pat. No. 5,078,311), carton board impregnated with resin (WO 9635574 A2), and carton reinforced with plastic or vulcanized fiber materials (JP 8309890 A dated 19950522). U.S. Pat. No. 6,173,876, Sano et al. discloses a dispenser carton having a serrated cutting edge.

### SUMMARY

The present invention provides a cutting edge formed of a tape for use with cartons. The cutting edge is adhered to container board, e.g., corrugated container board or box board, that is converted to blanks that are used to form cartons for holding convolutely wound wrapping materials and dispensing the same. The cutting edge includes a tape adhered to the board through an adhesive. The tape and board are die cut during the manufacture of the carton blank. During the die cutting process the tape backing, the adhesive and the container board are cut along a score line of the carton blank to form cut lines on opposite sides of the score line. The cut-lines define teeth. The teeth are generally triangular in shape and are formed by V-shaped cuts. The bases of the triangle, i.e., open end of the “V”, are adjacent the score line and are staggered relative to each other.

In the carton forming process a tape that includes a backing coated with an adhesive is contacted with the carton board. In the case of the corrugated container board, the tape that forms part of the cutting edge is incorporated into the carton blank during the process of forming the corrugated container board. In one corrugated board embodiment, the tape is contacted with a first substrate, e.g., the inside surface of the substrate that will form the outside liner of the corrugated board. In this embodiment, the tape adhered to the corrugated board includes an adhesive composition on both sides of the tape backing. A second substrate, e.g., a laminate of corrugated or fluted paper stock adhered to an inside liner, is brought into contact with the inside surface of the outside liner and the adhesive on the tape. The four layers are laminated as they are heated and pressed together in a nip area.

Heat and pressure present in the corrugating process activates the adhesive on the tape and bonds the tape backing to the components of the corrugated container board with which it is in contact. A starch adhesive, as is commonly used in the construction of corrugated boards, is activated by heat and pressure to bond the fluted medium to the inside surfaces of the inside liner and the outside liner of the corrugated board.

In another corrugated board embodiment, the tape is contacted with the outside surface of corrugated container board. In this case there is adhesive on only one side of the tape backing.

The finished web of corrugated container board is then passed through a cutter, which cuts the web into sheets. The sheets are then fed into a die cutter, which cuts each sheet to the form of a container blank and forms the score lines that define the panels of a container (e.g., a carton or a box). A die cutter also forms cut-lines in the blank in the area of the tape. The cut-lines define intersecting cuts, which define individual teeth on each side of a score line. The teeth are “V-shaped” with a pointed end and the wide area of each tooth is adjacent and on opposite sides of the score line. The cut lines on one side of the score line do not intersect or communicate with the cut-lines on the opposite side of the score line. The teeth are spaced along the score line such that the cut lines do not intersect or communicate with the cut-lines of adjacent teeth on the same side of the score line. The blank so formed is then ready to be shipped to a customer who then folds the blank to form the container. The folding of the blank raises the teeth from the blank thereby forming a cutting edge.

In the container forming process that employs box board (e.g., a sheet of box board or a web of box board), a tape is adhered to the box board (e.g., the exterior of the board, interior of the board, or a combination thereof). The board is then fed into a die cutter, which cuts the board to the form of a container blank and forms the score lines that define the panels of the box. A die cutter also forms cut-lines in the blank in the area of the tape. The cut-lines define intersecting cuts, which define individual teeth on each side of a score line. The teeth are “V-shaped” with a pointed end and the wide area of each tooth is adjacent and on opposite sides of the score line. The cut lines on one side of the score line do not intersect or communicate with the cut-lines on the opposite side of the score line. The teeth are spaced along the score line such that the cut lines do not intersect or communicate with the cut-lines of adjacent teeth on the same side of the score line. The blank so formed is then ready to be shipped to a customer who then folds the blank to form the box. The folding of the blank along the score line running congruent with a center line of the tape raises the teeth from the blank thereby forming a cutting edge.

The method of forming the cutting teeth on the carton includes applying a length of tape to the board from which the carton will be made, adhering the length of tape to the board (e.g., the exterior surface of the board, the interior surface of the board or a combination thereof), and die cutting the tape, adhesive and board to form triangular-shaped teeth in the tape on opposite sides of a fold line in the carton blank formed from the board.

The tape includes a polymeric film backing selected from the group of polymeric films including, e.g., polyester, polypropylene, polyethylene and polymeric materials having strength sufficient to support the cutting function. Preferably the backing is polyester.

Other features and advantages will be apparent from the following description of the preferred embodiments and from the claims.

### BRIEF DESCRIPTION OF THE DRAWINGS

The present invention will be further described with reference to the accompanying drawing wherein:

FIG. 1 is a schematic view of the blank forming machine for container board blanks;

FIG. 2 is a rear elevational view of the blank formed according to FIG. 1 and showing the present invention;

FIG. 3 is an enlarged view showing the design of the cuts forming the teeth;

FIG. 4 is an elevational view of the tape with the cut-line pattern;

FIG. 5 is a perspective view of a tape being folded along an imaginary fold line or score line to illustrate the teeth separating from the remainder of the tape;

FIG. 6 is a perspective view of a tape illustrating the tape folded upon itself and the teeth sticking straight in the plane of the tape halves;

FIG. 7 is a perspective view of a corrugated dispensing box formed according to the present invention from the blank of FIG. 2;

FIG. 8 is a cross sectional view of the cutting edge on the box of FIG. 7;

FIG. 9 is a cross sectional view of a cutting edge according to the present invention formed on an edge of a carton; and

FIG. 10 is a cross sectional view of a cutting edge according to the present invention formed on the lower front edge of a carton.

### DETAILED DESCRIPTION

The present invention provides a cutting edge formed by a polymeric tape adhered to containers (e.g., cartons or boxes) for dispensing a web and severing the web into a sheet including, e.g., polymeric wrapping film, paper (including e.g., waxed paper), metal wrapping foil and combinations thereof.

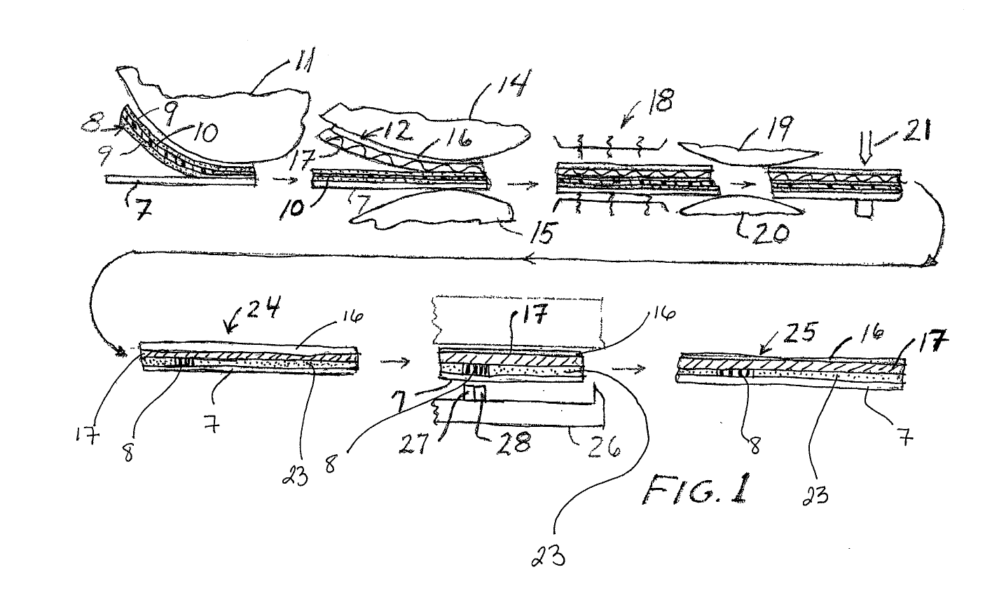

Referring now to the drawings, FIG. 1 illustrates, schematically, a process of forming a corrugated box blank that includes applying a tape to a board. As the substrate forming the outside liner 7 is fed into the machine, a tape 8 is brought into contact with the liner 7. The liner 7 is typically a paper facing. The tape 8 includes a polymeric backing 10, preferably coated on one or both sides with an adhesive 9, preferably a hot melt adhesive.

For use in the present invention, the polymeric backing 10 is formed of polyester, polypropylene, polyethylene or similar polymeric material having sufficient strength to support the cutting function. Preferably the polymeric backing is polyester. The backing is heat resistant between about 160° F. (71° C.) and about 350° F. (177° C.), preferably at least 250° F. (121° C.). The backing 10 has a thickness between 2 mils (0.05 mm) and 7 mils (0.18 mm), preferably 4 mils (0.1 mm), with a width of 0.5 inch (0.60 cm) to 1.25 inches (3.2 cm).

Suitable adhesives 9 include, e.g., pressure sensitive adhesives and hot melt adhesives. The hot melt adhesive can be any typical hot melt adhesive or hot melt pressure-sensitive adhesive such as an ethylene-vinyl acetate copolymer-based hot melt adhesive, a metallocene-based hot melt pressure-sensitive adhesive such as those comprising at least one homogeneous linear or substantially linear interpolymer of ethylene and at least one C₃ to C₂₀ alpha-olefin, ethylene methacrylate-based hot melt and hot melt pressure-sensitive adhesive, ethylene n-butyl acrylate-based hot melt adhesive, hot melt adhesives based on polyethylene and polypropylene homopolymers, copolymers and interpolymers, and rubbery block copolymer hot melt adhesives. In general, if ethylene-vinyl acetate-based hot melt adhesives are used, they typically comprise about 15% to about 40% ethylene-vinyl acetate, about 10% to about 35% wax, about 20% to about 40% resin, and about 0.2% to about 0.4% anti-oxidant. These adhesives exhibit good adhesion to the carton board.

The backing 10 can be treated to improve its adhesion to the adhesives. The adhesive can be adhered to either side of the board. When the adhesive tape is incorporated inside a corrugated board, as illustrated in FIG. 1, both sides of the tape backing will be coated with adhesive 9.

As the tape 8 is brought into contact with the liner 7 under an applicating roller 11, the tape 8 is placed on the inside of the liner 7.

The next step is to bring a web 12 into contact with the tape 8 and the liner 7. This is done between nip rollers 14 and 15. The web 12 includes an inside liner 16 and a corrugated or fluted paper medium 17 adhered to the inside liner 16. This laminated construction continues down the processing line. The hot melt adhesive 9 that adheres the tape 8 to the outside liner 7 and to the fluted medium 17 is activated in the presence of heat 18 and nip rollers 19 and 20. The starch adhesive 23 that adheres the fluted medium 17 to the outside liner 7 is also activated in the presence of heat 18 and nip rollers 19 and 20. The resulting corrugated board then moves to a guillotine-like cutting knife 21, which cuts the web into sheets 24.

Alternatively, the tape can be applied to a sheet (i.e., after the web is cut into a sheet) by a tape applicator of the type disclosed in co-pending application Ser. No. 09/703,968 filed Nov. 1, 2000, entitled, “Web Material Advance System for Web Material Applicator,” the disclosure of which is incorporated herein by reference.

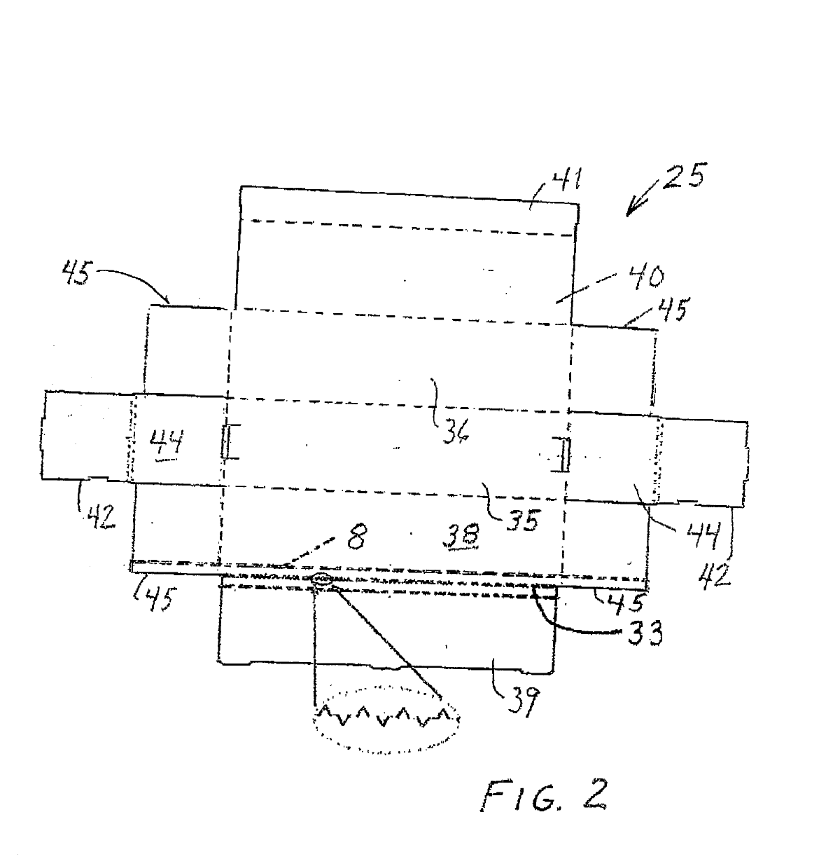

The sheets 24, now illustrated as rotated 90° in FIG. 1, are then conveyed into a die cutter die 26 having two rows of cutting knives 27 and 28. The die cutter 26 cuts the sheets 24 into blanks 25. In the die cutter 26 the sheets 24 are cut into the form of a blank 25 for a container. A blank 25 is illustrated in FIG. 2. The two rows of cutting knives 27 and 28 form cuts in the sheet 24 in the area of the tape 8 to cut a plurality of transverse slits along the length of the tape 8 and adjacent a score line 33. The cuts form cut-lines 30 in the container board and the tape 8. Pairs of cut-lines form a triangular area defining a tooth having a point and a base. The cut-lines form teeth 31 on opposing sides of an imaginary line extending lengthwise of the tape and board. The imaginary line is congruent with a score line 33 and the cut-lines forming each tooth 31 are spaced from other cut-lines forming other teeth 31 along the score line 33. The teeth 31 are formed on opposite sides of the line with the base of the teeth adjacent the score line 33. The teeth on opposite sides of the line are staggered.

The illustrated box blank 25 in FIG. 2 is a plan view of the inside of the container and includes the bottom panel 35 and sides walls 36 and 38. Side wall 38 forms the front panel. The front panel is joined to a reinforcing panel 39 at the score line 33. A lid 40 and closing flap 41 are joined to the rear panel 36 at score lines. The ends of the carton are formed by end flaps 42 and 44, which are folded upon themselves, with flap 42 being folded in alignment with and after flaps 45 are folded on adjoining score lines into alignment with flap 44.

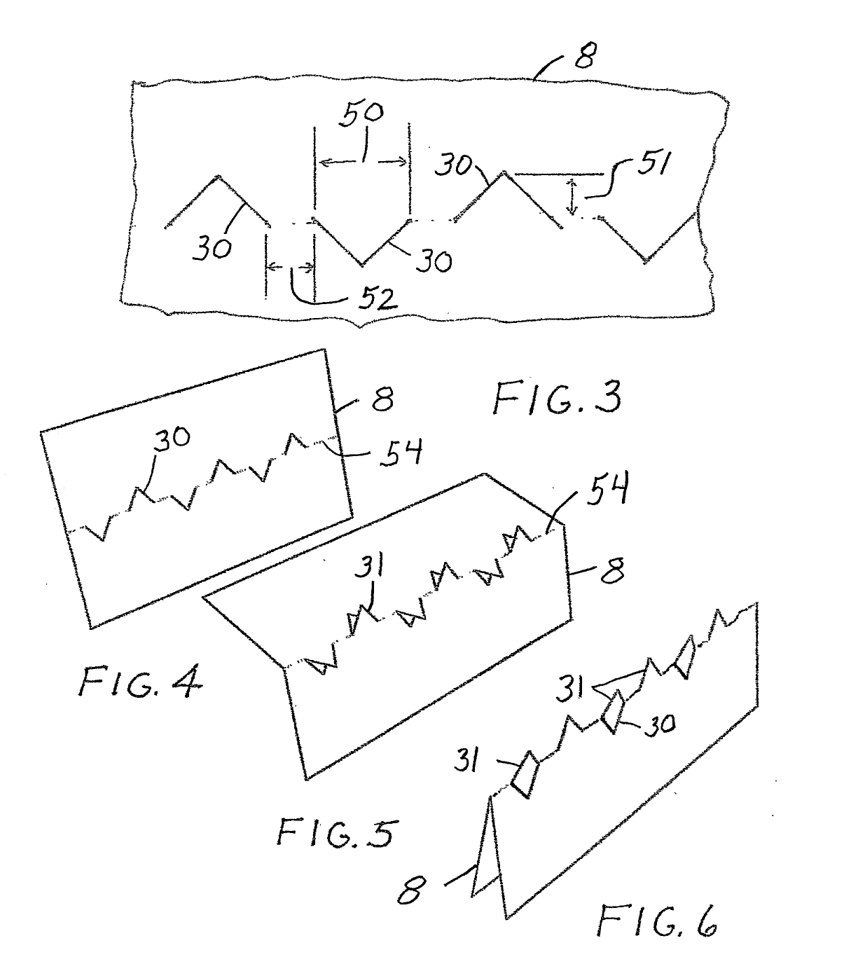

The cut-lines 30 and the individual teeth 31 are illustrated in FIGS. 3-6. The teeth 31 are formed with the base of the triangular shaped teeth adjacent the center or imaginary line 54 along the length of the tape 8. The cut-lines 30 generally do not cross the imaginary line, but cut-lines extending across the line, or score line, do not alter the effectiveness of the teeth. The dimensions of the teeth, and their spacing, can vary as required by the product being dispensed from the container. In one example, the width 50 of the base of the teeth 31 is 0.07 inch (1.77 mm). The height 51 of the teeth is generally 0.05 inch (1.27 mm). The teeth are spaced a distance 52, of 0.05 inch (1.27 mm) and are staggered in relationship to the imaginary line 54 as illustrated.

When the tape 8 is folded along the line 54, as indicated in FIGS. 5 and 6, the teeth 31 are raised out of the cut areas defined by the cut lines and project in the plane of the tape to which they are attached. As the carton is folded, portions of the laminate in the area of the teeth may delaminate such that the teeth 31 that form the cutting edge include one or more layers of the laminate construction including, e.g., the tape backing 10, the adhesive layer 9, at least a portion of the carton board, or a combination thereof.

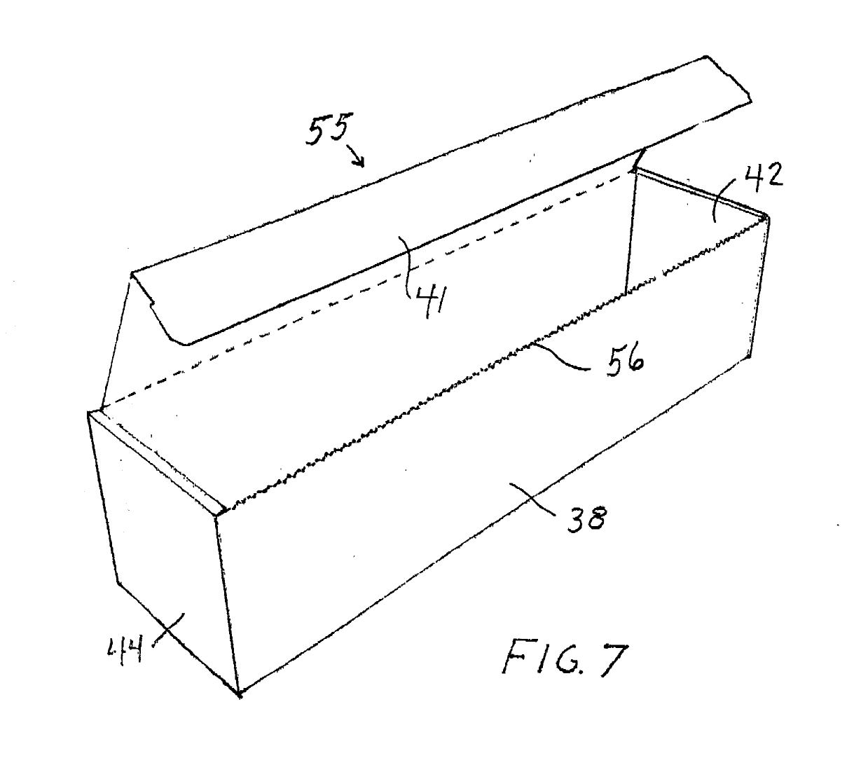

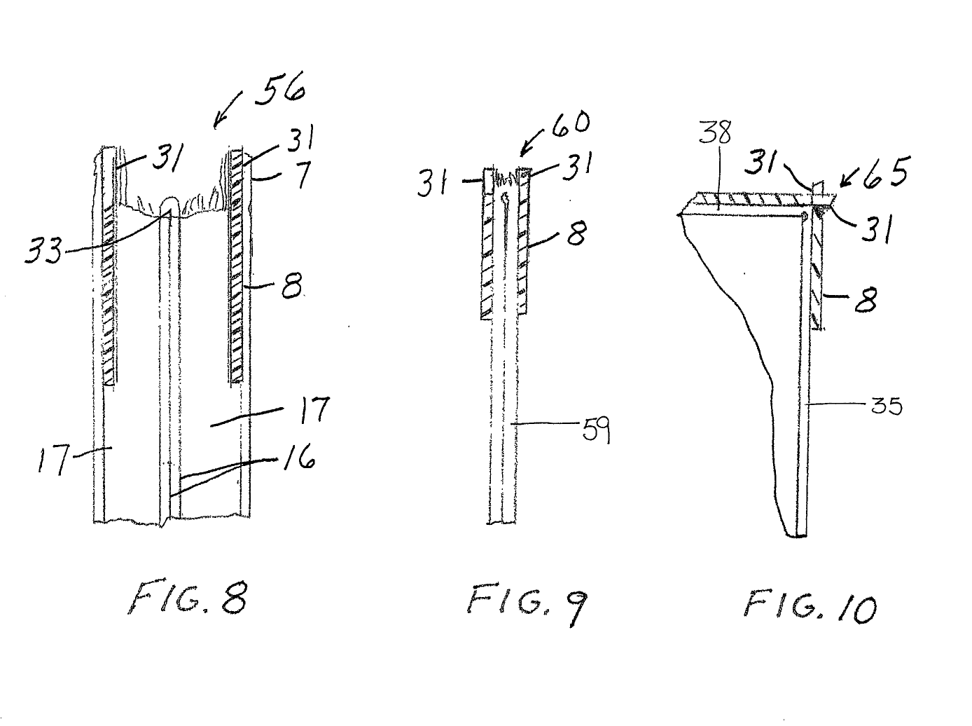

The folded box 55 from blank 25 is shown in FIG. 7. The folding of the panel 39 about the score line 33 causes the folding of the tape 8 and the virtual teeth defined by the cut-lines 30 to separate from the tape 8 and break through the outside liner 7 to form a cutting edge 56 along the top edge of the front panel 38. A cross section of this fold is illustrated in FIG. 8. Although not to scale, it is seen that the tape 8 will tear along the score line to form teeth that break through the liner 7 to an erect position along the top of the front panel.

The teeth are also useful on carton board for packages of wrapping material. If the fluted material is not added, the tape 8 is coated with the adhesive 9 on only one side and is adhered to the carton board or fiber board 59, as shown in FIG. 9. The teeth 31 are die cut as shown in FIGS. 3-6 and the blank, similar to the blank 25 is folded with the tape on the outside of the panel 38 and form a cutting edge 60 as illustrated in FIG. 9. This is similar to the cutting edge shown in FIG. 6.

Alternatively, the tape 8 can be placed over an edge of the blank, e.g. over a score line between panels 35 and 38 and when the box is formed, the teeth 31 separate from the tape 8 along the cut-lines and form a cutting edge 65, as illustrated in FIG. 10. The teeth will extend from the tape as illustrated in FIG. 5.

Having disclosed the present invention and equivalents thereof, it is to be understood that other changes can be made there in without departing from the spirit and scope of the invention claimed in the appended claims.

What is claimed:

1. A process of forming a virtual cutting edge on a carton blank, comprising the steps of
contacting a tape having a film backing and a coating of an adhesive with one surface of a board selected from the group consisting of container board and box board,
cutting a plurality of cut-lines in the board and tape such that pairs of the cut-lines form a triangular area defining a tooth shape having a point and a base, said pairs of cut-lines forming teeth on opposing sides of an imaginary line extending lengthwise along the tape and the board, said teeth being spaced apart along said line.

2. The process of claim 1, wherein said adhesive comprises a hot melt adhesive.

3. The process of claim 1, wherein said adhesive comprises a pressure sensitive adhesive.

4. The process of claim 1, wherein said board comprises box board.

5. The process of claim 1, wherein said board comprises corrugated container board.

6. A process of forming a virtual cutting edge on a carton blank, comprising the steps of
contacting a first adhesive surface of an adhesive tape with a first substrate,
said tape comprising a film backing, a first adhesive composition disposed on a first surface of said backing, a second adhesive composition disposed on a second surface of said backing,
said first substrate comprising a first component of a container board;
contacting said second adhesive surface of said tape with a second substrate to form a laminate, said second substrate comprising a second component of a container board; and
cutting a plurality of cut-lines in said laminate such that pairs of cut-lines form a triangular area defining a tooth shape having a point and a base, said pairs of cut-lines forming teeth on opposing sides of an imaginary line extending lengthwise along said tape, said teeth being spaced apart along said imaginary line.

7. The process of claim 6, wherein said second substrate comprises fluted material adhered to an inside liner.

8. The process of claim 6, wherein said adhesive comprises hot melt adhesive.

9. The process of claim 6, wherein said adhesive comprises pressure sensitive adhesive.

10. The process of claim 6, wherein said film backing comprises polymer.

11. The process of claim 6, wherein said board comprises corrugated container board.

12. A carton blank comprising
a first board comprising a container board, a box board, or a component thereof;
a tape bonded to said first board, said tape comprising a backing and an adhesive coated on one surface of said backing; and
a plurality of cuts in said tape and said first board, said cuts defining cut-lines,
wherein pairs of cut-lines form a triangular area defining a tooth shape having a point and a base, said pairs of cut-lines forming a plurality of teeth on opposing sides of an imaginary line extending lengthwise along said tape and said first board, said teeth being spaced apart form one another along said imaginary line.

13. The blank of claim 12, wherein said teeth formed by the cut-lines on one side of said imaginary line are staggered from the teeth on the other side of the line, the bases of said teeth being adjacent said imaginary line.

14. The blank of claim 12, wherein said adhesive comprises a hot melt adhesive selected from the group consisting of ethylene-vinyl acetate-based hot melt adhesive, a metallocene-based hot melt pressure-sensitive adhesive, ethylene methacrylate-based hot melt adhesive, ethylene methacrylate-based hot melt pressure-sensitive adhesive, ethylene n-butyl acrylate-based hot melt adhesive, polyethylene hot melt adhesive, polypropylene hot melt adhesive, rubbery block copolymer hot melt adhesive and combinations thereof.

15. The blank of claim 14, wherein said hot melt adhesive comprises homogeneous linear or substantially linear interpolymer of ethylene and C₃ to C₂₀ alpha-olefin.

16. The blank of claim 12, wherein said first board comprises a first board component, said blank further comprising a second board component comprising a fluted paper medium and an inside paper lining, said second board component bonded to said tape and said first board to form a laminate, said cuts extending through said laminate in the area of said tape to form said teeth.

17. The blank of claim 12, wherein said blank comprises a bottom panel, a front panel, a back panel, a lid and end closing panels, said panels being defined by score lines.

18. The blank of claim 16, wherein said blank comprises a bottom panel, a front panel, a back panel, a lid and end closing panels defined by score lines.

19. The blank of claim 12, wherein said tape is bonded to said first board along a score line, said imaginary line being congruent with said score line.

20. The blank of claim 17, further comprising a reinforcing panel joined to said front panel, said the tape being positioned over a score line between said front panel and said reinforcing panel.

21. The blank of claim 17, wherein said tape is positioned over the score line between said bottom panel and said front panel.

22. A carton comprising
box board panels including a bottom panel, a front panel, a front reinforcing panel, a back panel, a lid, a flap, end closing panels, and score lines connecting adjacent panels; and
a length of tape adhered to said box board and positioned congruent to a score line, said tape having a polymeric backing coated on one side with adhesive,
said tape and box board having a plurality of cuts defining cut-lines, wherein pairs of cut-lines form a triangular area defining a tooth shape having a point and a base,
said cut-lines forming a plurality of teeth on opposing sides of said score line, said teeth being spaced apart from one another along said score line.

23. A carton according to claim 22, wherein the teeth formed by cut-lines on one side of the score line are staggered from the teeth on the other side of the score line, the bases of the teeth being adjacent the line.

24. A carton according to claim 23, wherein the adhesive is a hot melt adhesive selected from the group consisting of ethylene-vinyl acetate-based hot melt adhesive, a metallocene-based hot melt pressure-sensitive adhesive, ethylene methacrylate-based hot melt adhesive, ethylene methacrylate-based hot melt pressure-sensitive adhesive, ethylene n-butyl acrylate-based hot melt adhesive, polyethylene hot melt adhesive, polypropylene hot melt adhesive, rubbery block copolymer hot melt adhesive and combinations thereof.

25. The carton of claim 24, wherein said hot melt adhesive comprises homogeneous linear or substantially linear interpolymer of ethylene and C₃ to C₂₀ alpha-olefin.

26. A process of forming a virtual cutting edge on a carton blank, said process comprising:
contacting a tape with a first substrate, said tape comprising a film backing and a an adhesive composition disposed on said backing; and
cutting a plurality of cut-lines in the first substrate and tape such that pairs of cut-lines form a triangular area defining a tooth shape having a point and a base, said pairs of cut-lines forming teeth on opposing sides of an imaginary line that extends lengthwise along the tape and the first substrate, said teeth being spaced apart along said imaginary line.

27. The process of claim 26, wherein said tape further comprises an adhesive composition disposed on a second surface of said backing, opposite said first surface, said process further comprising
contacting said second adhesive coated side of said tape with a second substrate.

28. The process of claim 26, wherein said second substrate comprises a fluted material adhered to a liner.

29. The process of claim 26, further comprising:
laminating a second substrate to said tape and said first substrate, said second substrate comprising a laminate of fluted material and a liner;
cutting the laminated construction into a carton blank; and
forming cut-lines through the carton blank in the area of the tape.

30. The process of claim 26, wherein said adhesive comprises hot melt adhesive.

31. The process of claim 26, wherein said first adhesive and said second adhesive comprise hot melt adhesive.

32. The process of claim 26, wherein said adhesive comprises pressure sensitive adhesive.

33. A carton blank comprising
a first substrate;
a tape comprising a backing and an adhesive disposed on a first surface of said backing, said backing being bonded to said first substrate through said adhesive; and
a plurality of cuts in the tape and first substrate defining cut-lines, pairs of cut-lines forming a triangular area defining a tooth shape having a point and a base, said pairs of cut-lines forming a plurality of teeth on opposing sides of an imaginary line extending lengthwise along said tape and said first substrate, said teeth being spaced apart form one another along said imaginary line.

34. The carton blank of claim 33, wherein the teeth formed by said cut-lines on one side of the imaginary line are staggered relative to teeth on the other side of the line, the bases of the teeth being adjacent the line.

35. The carton blank of claim 33, wherein said adhesive comprises a hot melt adhesive.

36. The carton blank of claim 35, wherein said hot melt is selected from the group consisting of ethylene-vinyl acetate-based hot melt adhesive, a metallocene-based hot melt pressure-sensitive adhesive, ethylene methacrylate-based hot melt adhesive, ethylene methacrylate-based hot melt pressure-sensitive adhesive, ethylene n-butyl acrylate-based hot melt adhesive, polyethylene hot melt adhesive, polypropylene hot melt adhesive, rubbery block copolymer hot melt adhesive and combinations thereof.

37. The carton blank of claim 35, wherein said hot melt adhesive comprises homogeneous linear or substantially linear interpolymer of ethylene and C₃ to C₂₀ alpha-olefin.

38. The carton blank of claim 33, further comprising a second substrate comprising a fluted paper medium and an inside paper lining, said second substrate being bonded through said adhesive to said backing to form a laminate, said cuts extending through said laminate in the area of said tape to form said teeth.

39. The carton blank of claim 33, wherein said blank comprises a bottom panel, a front panel, a back panel, a lid and end closing panels defined by score lines.

40. The carton blank of claim 33, wherein said tape is bonded to said board along a score line, the imaginary line being congruent with the score line.

41. The carton blank of claim 33, wherein said tape is positioned uniformly along a score line, the imaginary line being congruent with the score line.

42. The carton blank of claim 33, further comprising a reinforcing panel, said reinforcing panel adjacent the front panel, said tape positioned over a score line between said front panel and said reinforcing panel.

43. The carton blank of claim 33, wherein said tape is positioned over a score line between said bottom panel and said front panel.

44. A carton comprising
box board comprising a plurality of panels comprising a bottom panel, a front panel, a front reinforcing panel, a back panel, a lid, a flap, and end closing panels, and score lines disposed between adjacent panels;
tape adhered to said box board, said tape comprising a polymeric backing and an adhesive disposed on said backing, said tape being positioned congruent to a score line; and
a cutting edge comprising a plurality of teeth defined by a plurality of pairs of cut-lines on opposing sides of a score line, said teeth comprising a triangular shape having a point and a base and being spaced from each other along said score line.

44. The box of claim 44, wherein teeth formed by pairs of cut-lines on one side of said score line are staggered from teeth on the other side of said score line, said bases of said teeth being adjacent said score line.
